(19) United States
(12) Patent Application Publication
(10) Pub. No.: US 2004/0155097 A1
(43) Pub. Date: Aug. 12, 2004

(54) Soldering method and method for manufacturing component mounting board

(75) Inventors: Atsushi Yamaguchi, Osaka (JP); Masato Hirano, Osaka (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd.

(21) Appl. No.: 10/770,292

(22) Filed: Feb. 2, 2004

(30) Foreign Application Priority Data
Feb. 4, 2003 (JP) P.2003-026745

(51) Int. Cl. B23K 35/12

(52) U.S. Cl. 228/254

(57) ABSTRACT

Deterioration of a joining portion caused by a Cu—Zn compound layer is prevented by forming compound or alloy of Cu and Sn at the joining interface including a Cu surface to be a joining portion of a circuit board and an electronic component and then carrying out soldering by use of a soldering material containing Sn and Zn in composition.

The present application is based on Japanese Patent Application No. 2003-026745, which is incorporated herein by reference.

### BACKGROUND OF THE INVENTION

1. Field of the Invention

The present invention relates to a soldering method to carry out component mounting to an electronic circuit board and a method for manufacturing a component mounting board by soldering a circuit board and electronic components.

2. Description of the Related Art

In recent years, as to electronic component mounting, requests to improvement in mechanical strength of soldering portions and to improvement in reliability characteristics such as thermal shock resistance have been increased. On the other hand, with a growing interest in protection of the global environment, regulation by law is also being promoted as to industrial waste disposal of the electronic circuit board or the like. Accordingly, development relating to soldering satisfying both demands has been needed.

The main components of the conventional soldering material are Sn and Pb and the material has a composition of 63Sn—37Pb.

In a soldering method where the conventional soldering material is used, a joining structure of an electronic component and an electronic circuit board is hereinafter illustrated through drawings.

FIG. 3 is a schematic view of a joining structure where a conventional soldering material is used. In FIG. 3, 1 is a soldering material, which comprises Sn and Pb as components, 2 is an electrode of an electronic component, 3 is a land of an electronic circuit board, which contains Cu as a component, and 4 is a compound layer comprising Cu and Sn, which is formed at a joining interface. The conventional soldering material has a comparatively low melting point and reliability of the joining portion is also practically sufficient under the circumstance of high temperature and high humidity. However, the soldering material where Pb is used is unpreferable in view of protection of the global environment as described above.

Therefore, use of a lead-free solder that is a soldering material containing no lead may be recommended. However, a solder made of Sn and Ag as main components, which is an example of the lead-free solder, has a melting point higher by 30 to 40° C. than that of the Sn—Pb solder and the soldering temperature thereof is higher than that of the lead-containing solder. Therefore, the soldering temperature exceeds the heat-resistant temperatures of electronic components in some cases, and the lead-free solder has a disadvantage of causing damage to the electronic components. Furthermore, the solder has a problem of being inferior to the Sn—Pb solder also in view of wettability.

Use of a solder containing Sn and Zn as fundamental components and having a melting point higher by 10 to 20° C. than that of the Sn—Pb solder has also been thought.

FIG. 4 is a schematic view showing a joining structure where a soldering material containing Sn and Zn as fundamental components is used. In FIGS. 4, 5 is a Sn—Zn solder and 6 is a Cu—Zn compound layer formed at a joining interface of the land 3 that is a member to be joined. For example, see Unexamined Japanese Patent Publication No. Hei-09-094688.

Although soldering by the soldering material containing Sn and Zn as fundamental components reduces thermal damage to electronic components, the soldering material introduces a problem of deteriorating the joining portion in use of the electronic circuit board under the circumstance of high temperature and high humidity. Zn existing in the Cu—Zn compound layer 6 and the surface of the Sn—Zn solder 5 is eluted under the circumstance of high temperature and high humidity, which is thought to become a cause of the deterioration.

### SUMMARY OF THE INVENTION

The invention aims at realizing a joining portion excellent in resistance to high temperature and high humidity on the electronic circuit board.

In order to achieve the object, in a soldering method according to the invention, a compound or alloy of Cu and Sn is formed at the joining interface including a Cu surface in a joining portion between a first member and a second member to be joined, and then carrying out soldering by use of a soldering material containing Sn and Zn in composition. The Cu surface exists either on the first member or the second member, or both on the first and second members.

This method can prevent the deterioration of the joining portion caused by the Cu—Zn compound layer.

Furthermore, a component mounting board having a joining portion excellent in resistance to high temperature and high humidity can be also prepared by joining a circuit board and an electronic component by use of this soldering.

### BRIEF DESCRIPTION OF THE DRAWINGS

In the accompanying drawings:

FIG. 1 shows a schematic view showing a joining structure prepared by use of a soldering material containing Sn and Zn as fundamental components, joining structure relating to the mode for carrying out the invention;

FIG. 2 shows a schematic view showing a joining structure prepared by use of a soldering material that contains Sn and Zn as fundamental components and that a small amount of Ni is added to, joining structure relating to the mode for carrying out the invention;

FIG. 3 shows a schematic view showing a joining structure prepared by use of a conventional soldering material; and

FIG. 4 shows a schematic view showing a joining structure prepared by use of a soldering material containing Sn and Zn as fundamental components.

### DETAILED DESCRIPTION OF THE PREFERRED EMBODIMENTS

The invention is hereinafter illustrated through drawings. In the respective drawings, the same sign is given to the same component and the explanation thereof is omitted.

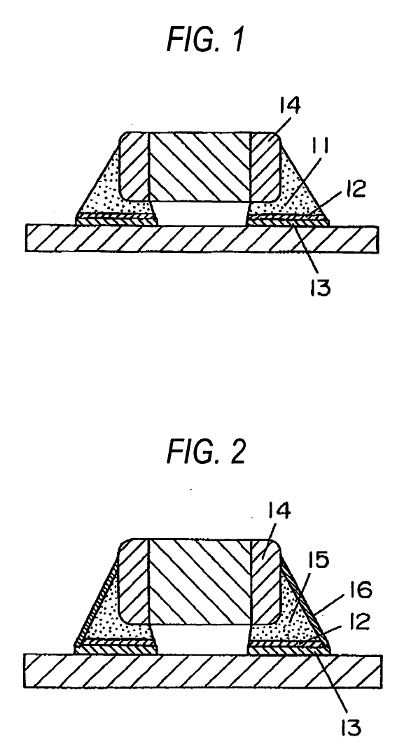

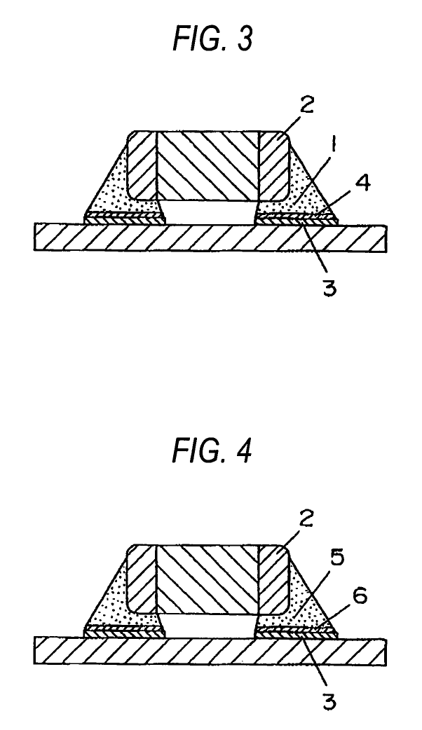

FIG. 1 is a schematic view showing a joining structure prepared by use of a soldering material containing Sn and Zn as fundamental components, joining structure relating to the mode for carrying out the invention. In FIG. 1, 11 is a Sn—Zn solder, 12 is a Cu—Sn compound layer formed at a joining interface, 13 is a land that is a member to be joined, and 14 is an electrode of an electronic component.

The Sn—Zn solder 11 has a melting point higher by about 10 to about 20° C. than that of the Sn—Pb solder. In the course of the development, it was found that when soldering to the Cu surface of the land 13 on an electrical circuit board was carried out in a condition where a compound or alloy of Cu and Sn was formed, such soldering had an effect of inhibiting the formation of a Cu—Zn compound due to direct reaction of the Cu parent material with Zn of the Sn—Zn solder 11 (Cu parent material reacts with Zn in the Sn—Zn solder 11 more preferentially than Sn). It was also found that the thickness of the compound or alloy of Cu and Sn exceeding 5 μm brought about hard and fragile properties to the compound or alloy to decrease strength of the interface. Therefore, when the soldering was carried out in a condition where a compound or alloy of having a thickness of 5 μm or less was formed on the Cu surface of the land 13 of an electronic circuit board, formation of the Cu—Zn compound due to direct reaction of the Cu parent material with Zn of the Sn—Zn solder 11 was inhibited, thus to obtain a joining portion excellent in resistance to high temperature and high humidity.

When a small amount of a metal undergoing oxidation more readily than Zn, for example, Ni is added to a solder beforehand, an oxide layer of the added metal can be preferentially formed on the surface of the solder. FIG. 2 is a schematic view showing a joining structure prepared by use of a soldering material that contains Sn and Zn as fundamental components and that a small amount of Ni is added to, joining structure relating to the mode for carrying out the invention. In FIG. 2, 15 is a soldering material that contains Sn and Zn as fundamental components and that a small amount of Ni is added to and 16 is a Ni oxide layer. The Ni oxide layer 16 acts to prevent elution of the Zn contained in the solder under the circumstance of high temperature and high humidity. The amount of Ni added to the solder is 0.1 weight percent or less and preferably 0.01 weight percent or less. The amount of Ni exceeding 0.1 weight percent causes a significant decrease in wettability of the solder to make it difficult to assure a sufficient quality of soldering. Then, the content of Zn is desirably from 5 to 10 weight percent. In addition, it is preferable that the soldering material contains from 0.1 to 5.0 weight percent of Bi.

A similar effect is also obtained when Al, Si, In, Mn, Ge, Mo, or P that is oxidized more easily than Zn and is not eluted under the circumstance of high temperature and high humidity is added in a small amount to the solder.

For formation of the compound of Cu and Sn, there is a method of covering the Cu surface with a metal containing Sn and then carrying out a thermal treatment. The covering of the Cu surface with the metal containing Sn can be carried out also by plating, immersing in fused metal, or vapor deposition. For the covering by the plating or vapor deposition, it is necessary to form the compound layer of Cu and Sn at the joining interface by a thermal treatment. Also in the method of immersing in fused metal, further growth of the compound layer of Cu and Sn by the thermal treatment can inhibit formation of the Cu—Zn compound layer to prepare a joining portion excellent in resistance to high temperature and high humidity.

The kinds of the covering include a Sn covering, a Sn—Bi covering, a Sn—Ag covering, a Sn—Cu covering, a Sn—Ag—Cu covering, a Sn—Ag—Bi covering, andthe like. The thickness of the covering is desirably adjusted to 10 μm or less. The reason for this is that exceeding 10 μm causes melting of the covering metal into the solder on soldering or allows the metal to remain on the interface, even if the metal does not melt, to cause deterioration in the characteristics of the joining portion.

Furthermore, although the layer formed at the joining interface was supposed to be a Cu—Sn compound layer, the layer may be a Cu—Sn alloy layer.

Furthermore, it is possible to develop a similar effect by preparing the Cu—Sn compound or alloy beforehand and setting it on a soldering portion.

Covering of a terminal electrode of the electronic component also provides an effect similar to the covering of the Cu land of the electronic circuit board.

Furthermore, it is also possible to manufacture a component mounting board having a joining portion excellent in resistance to high temperature and high humidity by soldering a circuit board and an electronic component according to the above-described method.

As described above, according to the invention, an advantageous effect of preventing deterioration of a joining portion caused by a Cu—Zn compound layer can be acquired by forming an compound or alloy of Cu and Sn at a joining interface with a Cu surface to be a joining portion and then carrying out soldering by use of a soldering material containing Sn and Zn in composition.

Furthermore, it is also possible to manufacture a component mounting board having a joining portion excellent in resistance to high temperature and high humidity by joining a circuit board and an electronic component with the aid of this soldering.

Although the invention has been described in its preferred form with a certain degree of particularity, it is understood that the present disclosure of the preferred form can be changed in the details of construction and in the combination and arrangement of parts without departing from the spirit and the scope of the invention as hereinafter claimed.

What is claimed is:

1. A soldering method comprising steps of:
forming a compound or an alloy of Cu and Sn at a joining interface including a Cu surface in a joining portion; and
soldering by use of a soldering material containing Sn and Zn in composition.

2. A method according to claim 1, wherein a thickness of the compound or the alloy is 5 μm or less.

3. A method according to claims 1, wherein a method for forming the compound of Cu and Sn is a method of covering the Cu surface with a metal containing Sn and carrying out a thermal treatment.

4. A method according to claim 3, wherein the covering is one of a Sn covering, a Sn—Bi covering, a Sn—Ag covering, a Sn—Cu covering, a Sn—Ag—Cu covering, and a Sn—Ag—Bi covering.

5. A method according to claim 3, wherein a method of covering is one of a plating, an immersion method, and a vapor deposition.

6. A method according to claim 3, wherein a thickness of the covering is 10 μm or less.

7. A method according to claim 1, wherein the soldering material further comprises a metal that is oxidized more easily than Zn in the soldering material.

8. A method according to claim 7, wherein said metal is selected from any one of the group consisting of Al, Ni, Si, In, Mn, Ge, Mo and P.

9. A method according to claim 8, wherein an amount of said metal is 0.1 weight percent or less.

10. A method for manufacturing a component mounting board by soldering a circuit board and an electronic component according to a method according to claim 1.

11. A method for manufacturing a component mounting board by soldering a circuit board and an electronic component according to a method according to claim 2.

12. A method for manufacturing a component mounting board by soldering a circuit board and an electronic component according to a method according to claim 3.

13. A method for manufacturing a component mounting board by soldering a circuit board and an electronic component according to a method according to claim 4.

14. A method for manufacturing a component mounting board by soldering a circuit board and an electronic component according to a method according to claim 5.

15. A method for manufacturing a component mounting board by soldering a circuit board and an electronic component according to a method according to claim 6.

16. A method for manufacturing a component mounting board by soldering a circuit board and an electronic component according to a method according to claim 7.

17. A method for manufacturing a component mounting board by soldering a circuit board and an electronic component according to a method according to claim 8.

18. A method for manufacturing a component mounting board by soldering a circuit board and an electronic component according to a method according to claim 9.
